(19) United States
(12) Patent Application Publication
(10) Pub. No.: US 2016/0082686 A1
(43) Pub. Date: Mar. 24, 2016

(54) MACHINE FOR THE CONTINUOUS MANUFACTURE OF TUBULAR BOX BODIES, NOTABLY BASED ON CARDBOARD OR THE LIKE

(71) Applicant: PAKEA SASU (Société par actions simplifiée unipersonnelle), Rixheim (FR)

(72) Inventors: Yves ROESCH, Munchhouse (FR); Michel INTERING, Hochstatt (FR)

(21) Appl. No.: 14/785,444

(22) PCT Filed: Apr. 9, 2014
(86) PCT No.: PCT/FR2014/000082

§ 371 Date: Oct. 19, 2015

(30) Foreign Application Priority Data
Apr. 22, 2013 (FR) 13/53638

(51) Int. Cl. B31F 7/00; B31F 1/00

(52) U.S. Cl. CPC B31F 7/004; B31F 1/0064; B31F 1/007

(57) ABSTRACT

A manufacturing machine in which the pressing mechanism (20), for rolling the strips of material (2) against the forming mandrel (3), and the traction mechanism (10), for moving the shaped strips of material along the forming mandrel (3), are distinct in order to separate these two functions. The pressing mechanism (20) comprises a plurality of deformable press rollers (21) mounted free in rotation about their axis and distributed radially around the forming mandrel (3) so as to fit the periphery of the mandrel. The traction mechanism (10) comprised several traction belts (11) carried by drive rollers (12) positioned downstream of the pressing mechanism (20).

### TECHNICAL SCOPE

The present invention relates to a machine for the continuous manufacture of tubular box bodies, notably based on cardboard or the like, this machine comprising at least one longitudinal forming mandrel whose cross-section corresponds to the internal cross-section of the tubular bodies of the boxes to be manufactured and around which at least one longitudinally unwound and previously at least partly glue-coated strip of material is applied and folded in order to form a closed tubular profile, this machine comprising moreover pressing means arranged for rolling said at least one strip of material against said forming mandrel, and traction means arranged for moving continuously said tubular profile along said forming mandrel.

### PRIOR ART

Such a machine is in particular described in publication FR 2 702 414 whose manufacturing process provides to fold the side flaps of every strip of material in an at least partly dissymmetrical way on the forming mandrel so that the folding of a first flap of a material strip is completed prior to the folding of the second flap of this strip of material, this folding being completed prior to that of a first flap of a subsequent strip of material. This manufacturing process allows producing tubular box bodies with very high quality, avoiding the buckling phenomena between the strips of material and ensuring an accurate geometry of the longitudinal joints in order to guarantee the required resistance of the tube wall in the area(s) where these joints are located.

In this type of machine, guiding and folding the strips of material on the forming mandrel are ensured by fixed guides, for example out of sheet metal. Then, the rolling of these strips of material around the forming mandrel to ensure their intimate bonding by gluing, as well as the longitudinal movement of the tubular profile formed by said strips of material, are ensured by traction belts driven and applied under pressure against said forming mandrel by rigid motorized press rollers, these traction belts being distributed radially around said forming mandrel.

The disadvantage of this type of design lies in the numerous operations required when starting the machine to introduce the strips of material between the fixed guides, then between the traction belts, to position properly the strips of material with respect to each other and around the forming mandrel, to adjust the position of said fixed guides, as well as the pressure of said press rollers and the tension of said traction belts. All these operations are difficult to carry out, require several operators simultaneously and generate substantial raw material scraps until achieving the optimum setting. Moreover, the use of fixed guides generates a high linear tension due to the friction between the continuously moving strips of material and the static guides, which must be compensated by efficient traction means. On the other hand, the use of traction belts combined with press rollers has the disadvantage of providing a relatively large rolling surface that is detrimental to the local pressure exerted on the strips of material and does not allow achieving a uniform pressure in all points of the periphery of said tube, nor to adapt to the thickness variations of the material strips, which are mostly made of cardboard. The cost of such a machine, its dimensions, the complexity of the work for changing the format of the tubular box bodies to be manufactured and ensuring the maintenance of such machine and the replacement of the wear parts compound these disadvantages.

### DESCRIPTION OF THE INVENTION

The present invention aims to overcome these disadvantages by offering a machine for the manufacture of tubular box bodies with a simpler design, representing a lower investment, with reduced dimensions, facilitating maintenance work, allowing a quick change of the format of the boxes to be manufactured, allowing automated and therefore faster start-up, with less raw material scrap, achieving better rolling of the strips of material against each other, which allows improving substantially the quality and mechanical strength of the produced box bodies, reducing or even suppressing the frictions and linear tensions and therefore allowing limiting the power of the traction means. Another scope of the invention consists in producing box bodies ensuring optimum tightness for the packagings requiring this feature.

To that purpose, the invention relates to a machine of the kind described in the preamble, characterized in that said pressing means and said traction means are distinct and in that said pressing means comprise a plurality of press rollers mounted free in rotation about their axis, said press rollers being deformable and radially distributed around said forming mandrel so as to fit the periphery of said mandrel.

The press rollers are preferably distributed symmetrically around said forming mandrel, each covering a sector of said mandrel, and are offset longitudinally in order to cover the whole periphery of said mandrel.

Advantageously, every press roller comprises a lining made out of an elastic material and having a profile complementary to that of the sector of the forming mandrel against which the corresponding press roller is applied.

The elastic lining of said press rollers can comprise internal recesses arranged to increase its elasticity. The elastic material of said lining can in addition be chosen in the group including the natural rubbers and the polyurethane-based synthetic rubbers.

In a preferred embodiment, each press roller is carried by a support whose radial position can be adjustable with respect to said forming mandrel and is coupled with a pressurizing element carried by said support.

The machine according to the invention can moreover comprise a longitudinal centering mandrel arranged upstream of said forming mandrel and having a polygonal cross-section whose development is smaller that the development of the internal cross-section of the tubular box bodies to be manufactured, said centering mandrel being arranged to guide said strips of material longitudinally and transversally without slipping.

It can also comprise a temporary longitudinal mandrel arranged downstream of said centering mandrel and upstream of said forming mandrel and having a water drop-shaped cross-section whose development corresponds to the development of the internal cross-section of the tubular box bodies to be manufactured.

In this case, it preferably comprises a welding station adjacent to said temporary mandrel to weld the longitudinal edges of at least one strip of material forming the internal layer of said tubular box bodies.

It finally can comprise a series of press rollers aligned on a longitudinal sector of said forming mandrel corresponding to an area where the longitudinal edges of said at least one strip of material meet to close said tubular profile by means of at least one longitudinal joint.

The traction means can comprise at least one traction belt carried by drive rollers and arranged downstream of said pressing means, and preferably at least two traction belts arranged symmetrically with respect to said forming mandrel.

Said machine can moreover comprise at least one gluing nozzle arranged to add glue on at least some of the longitudinal edges of said strips of material.

### BRIEF DESCRIPTION OF THE DRAWINGS

The present invention and its advantages will be better revealed in the following description of an embodiment given as a non limiting example, in reference to the drawings in appendix, in which:

FIG. 1 is a partial view of a manufacturing machine according to the invention showing only a part of the longitudinal forming mandrel, the press rollers and the corresponding traction belts,

FIG. 2 is a top view of a centering mandrel followed by a temporary mandrel, both located upstream of the forming mandrel of the machine according to FIG. 1,

FIG. 3 is a top view of the forming mandrel of the machine according to FIG. 1,

FIGS. 4A to 4J are cross-sectional views of the various mandrels represented in FIGS. 2 and 3, respectively along planes A to J,

FIGS. 5A and 5B are cross-sectional views of one of the press rollers respectively before and after applying it against the forming mandrel, and

FIG. 6 is a side view of the single press roll of FIGS. 5A and 5B.

### ILLUSTRATIONS OF THE INVENTION AND BEST WAY OF REALIZING IT

The machine 1 according to the invention is partially illustrated in the attached figures in order to show only the parts concerned by the present invention, without frame and enclosure, to facilitate understanding. This machine allows manufacturing tubular box bodies, notably based on cardboard or the like, for example for packaging food products or the like, by longitudinally unwinding one or several strips of material 2 wound in coils, said strips being coated with glue, superimposed to form a web and slightly offset laterally with respect to each other before being applied on a longitudinal forming mandrel 3 on which they are folded, pressed and rolled to form a tubular profile 4 closed by one or several offset longitudinal joints 5. This tubular profile 4 is then cut to the required length to form said tubular box bodies. The longitudinal joint 5 is achieved by gluing the superimposed longitudinal edges 6 of every strip of material 2, the longitudinal edges of every material strip being preferably offset laterally so that the longitudinal joints of said strips of material overlap, in order not to weaken the wall of the tubular box bodies in this junction area. If the tubular box bodies are made from one single strip of material, then this strip is made of a complex or composite material, that is to say made of several layers of materials that may be different or not, depending on the physical properties required for the tubular box bodies.

The machine 1 partially represented in the attached figures comprises a longitudinal forming mandrel 3 having a circular cross-section that corresponds to the internal cross-section of the tubular box bodies to be manufactured, which are consequently cylindrical. Of course, this machine 1 allows manufacturing tubular box bodies with any cross-section, such as polygonal, ovoid, or others.

The machine 1 according to the invention differs from the known machines by the fact that the “rolling” function of the strips of material on forming mandrel 3 and the “traction” function of the tubular profile formed by said strips of material are dissociated and performed by totally distinct traction means 10 and pressing means 20.

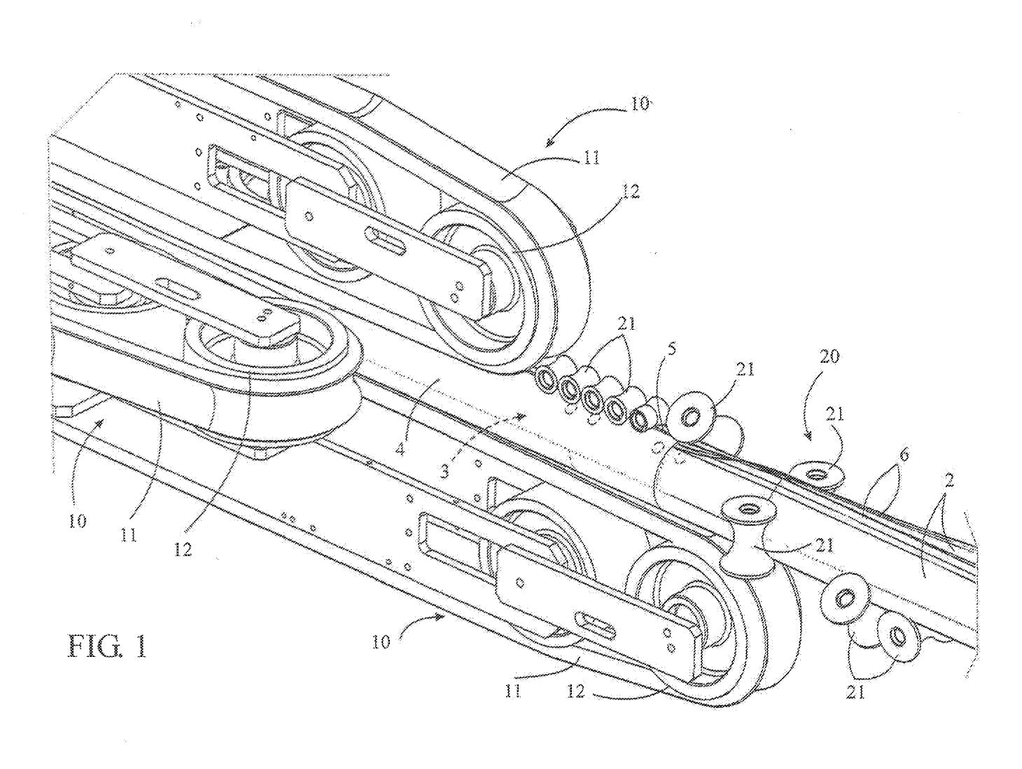

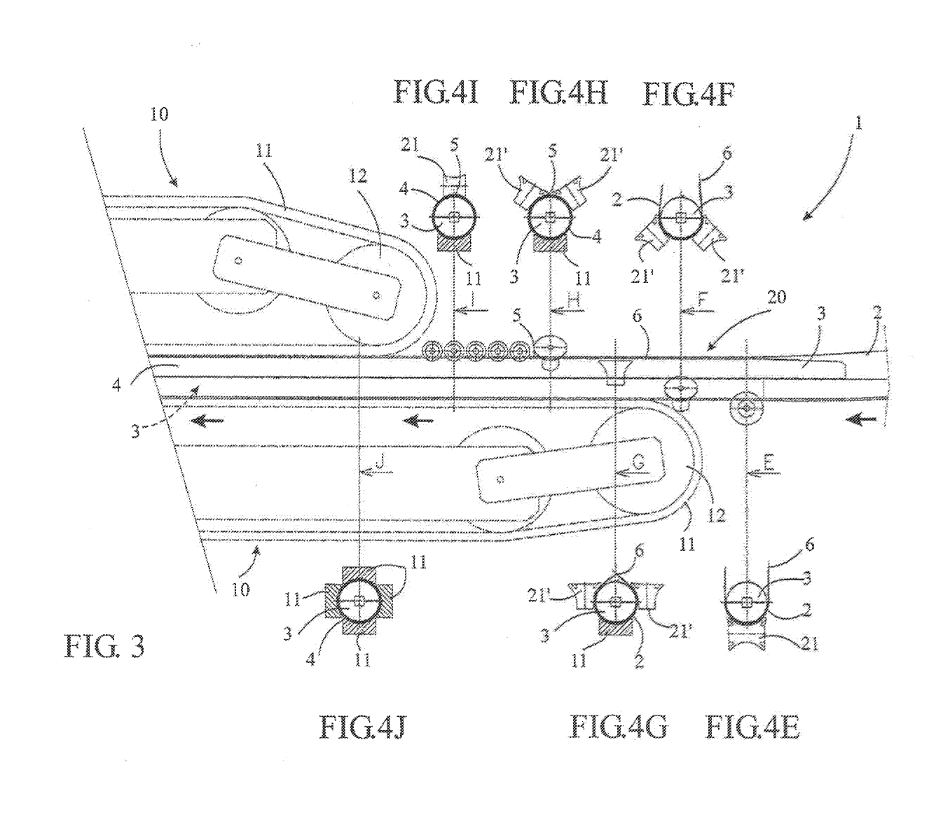

The traction means 10 visible on FIGS. 1 and 3 are arranged preferably downstream of pressing means 20, that is to say after the formation and closing of tubular profile 4 achieved by folding and rolling strips of material 2. They comprise one and preferably several traction belts 11 closed in a loop around at least two drive rollers 12 of which at least one is driven in rotation by a suitable actuator such as a motor or a servomotor. To ensure a traction effort uniformly distributed on tubular profile 4, one uses, as in the represented example, four traction belts 11I symmetrically distributed around said forming mandrel 3. The profile of traction belts 11 and drive rollers 12 is adapted and complementary to the sector of forming mandrel 3 they are applied against. In the represented example, this profile is cylindrical. Of course, the number of traction belts 11 can vary, as well as their layout, their design and their driving means.

Pressing means 20 comprise a plurality of deformable press rollers 21 mounted free in rotation about their axis and radially and longitudinally distributed around forming mandrel 3 so as to fit perfectly the whole periphery of this forming mandrel 3 to ensure uniform and powerful rolling of the web of strips of material 2 against forming mandrel 3 to further their cohesion and intimate bonding by gluing.

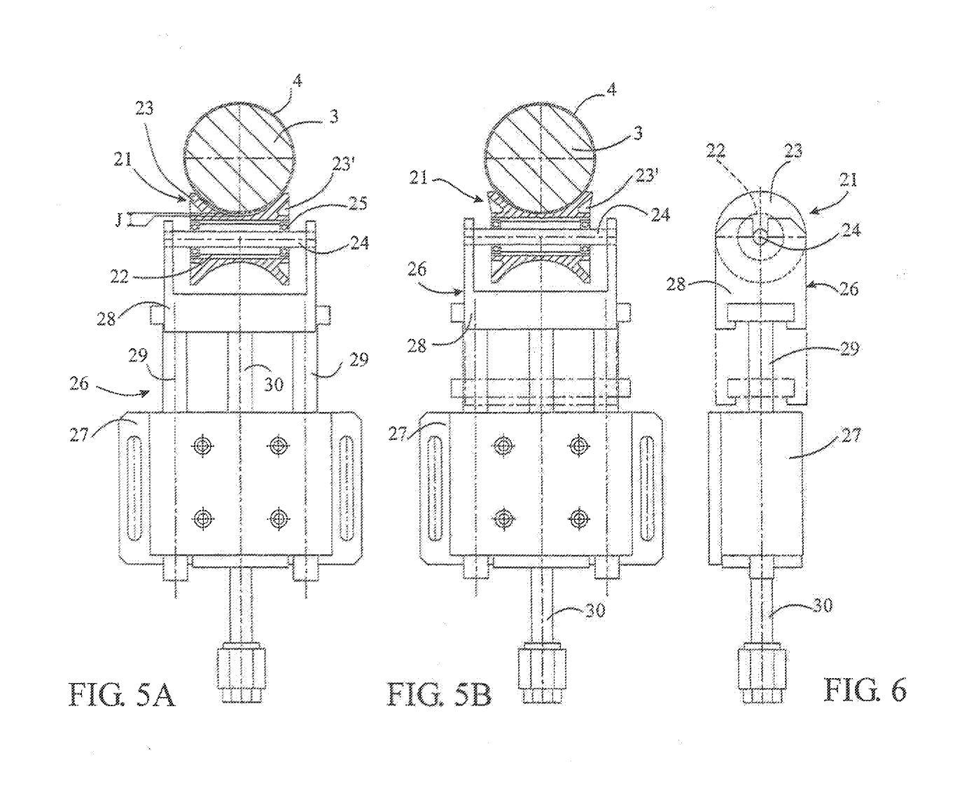

FIGS. 5 and 6 illustrate more in detail an example of these press rollers 21. Each press roller 21 comprises a shaft 22 carrying a lining 23 made out of an elastic material such as for example the natural rubbers and the polyurethane-based synthetic rubbers having a hardness, given as a non-limiting example, of about 60 Shore. The profile of this lining 23 is adapted and complementary to the sector of forming mandrel 3 the press roller 21 is applied against. In the example represented in FIGS. 5 and 6, this profile is cylindrical and its radius is smaller than or equal to that of forming mandrel 3. Depending on the needs, the press rollers used can be entire and therefore symmetrical press rollers 21, as those illustrated in FIGS. 1, 4E, 4I, 5A, 5B and 6, or half or truncated and therefore asymmetrical rollers 21′, as those illustrated in FIGS. 4F, 4G and 4H. Their design and operation nevertheless remain identical.

When press roller 21 is not pressed against forming mandrel 3, it defines a gap J between its lining 23, which is not constrained, and tubular profile 4 carried by forming mandrel 3 (see FIG. 5A). When it is pressed against forming mandrel 3 by the means described below, its lining 23 deforms to cancel gap J and fit perfectly the sector of tubular profile 4 it is pressed against, the corresponding sector of forming mandrel 3 behaving as a counter support (see FIG. 5B). Press roller 21 has the advantage of providing a contact surface limited to a generating line, therefore to a linear contact, thus allowing to exert a local pressure that is higher and more uniform than in the case of a rolling surface. Lining 23 can comprise internal recesses 23′ arranged to increase its elasticity.

Moreover, press roller 21 is mounted free in rotation about its axis and generates neither friction nor sliding on tubular profile 4. To reduce or even suppress the differential speeds in the end zones of press roller 21, the dimension of these press rollers 21 is reduced and their number is increased.

Shaft 22 of press roller 21 is mounted free in rotation about an axis 24 by means of ball bearings 25 or the like, while axis 24 is carried by a support 26. This support 26 comprises a plate 27 fastened on the frame (not represented) of machine 1 in order to be removable and radially adjustable with respect to forming mandrel 3, thus facilitating the maintenance and setting operations. This support 26 comprises a slide 28 guided in translation in plate 27 and carrying on its end said axis 24, which carries press roller 21. This slide 28 is moved in radial translation with respect to forming mandrel 3 by means of a linear actuator such as a jack (not represented) that allows pressing press roller 21 against forming mandrel 3 with a defined and adjustable pressure. This slide 28 comprises at least two guide columns 29 located symmetrically with respect to a central rod 30 prolongating the linear actuator, the two columns 29 and central rod 30 being arranged to slide in corresponding bores provided in plate 27. Of course, any other equivalent guiding and/or pressurizing means of press rollers 21 can be envisaged.

### POSSIBILITIES FOR INDUSTRIAL APPLICATION

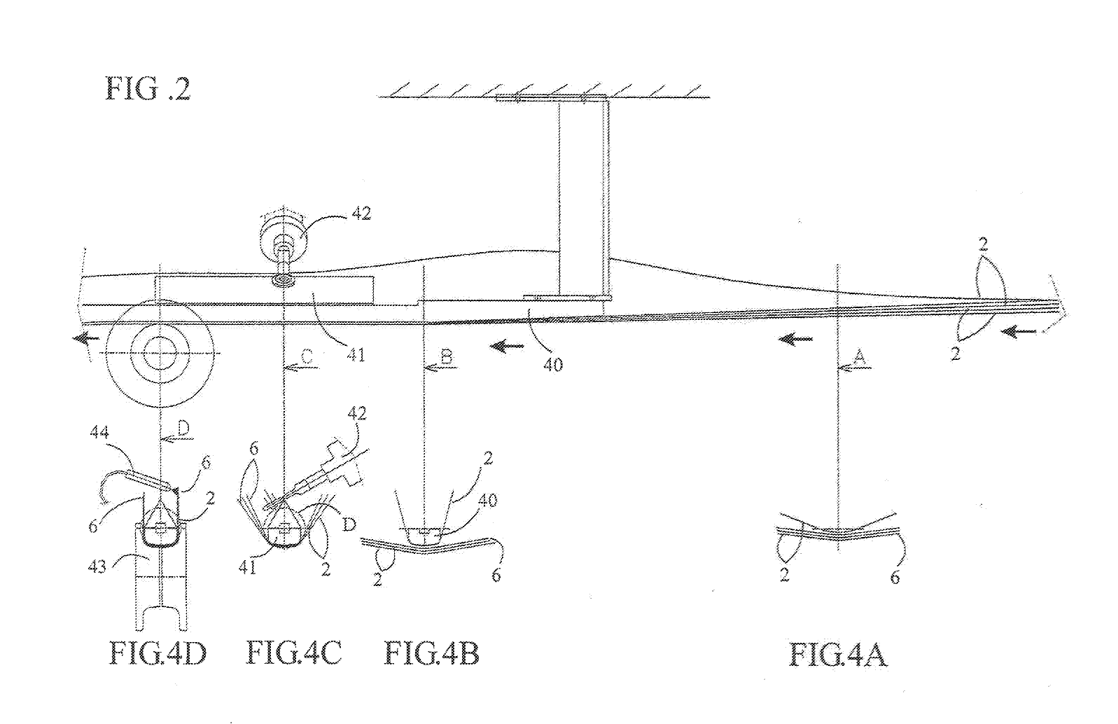

In the illustrated example, in particular in FIGS. 2 and 3, machine 1 comprises a longitudinal centering mandrel 40 (FIGS. 2 and 4B) arranged upstream of forming mandrel 3 and against which strips of material 2, which are unwound from their coils, previously coated with glue, superimposed in a web with a slight lateral offset as explained above and moved longitudinally by traction means 10 described previously, are brought into contact. Strips of material 2 will bend automatically without lateral guide (FIG. 4A) as they are longitudinally tensioned by traction means 10 from their unwinding zone up to forming mandrel 3, where they pass from the flat open state to a closed state, rolled up in a tubular profile 4. To that purpose, centering mandrel 40 has a polygonal cross-section whose development is smaller than the development of the internal cross-section of the tubular box bodies to be manufactured and whose function is to guide longitudinally and transversally the web of strips of material 2 without slipping. This way, the lateral offset imposed between strips of material 2 is preserved, which allows guaranteeing the quality of the longitudinal junction zone of tubular profile 4 and the mechanical strength of the tubular box bodies manufactured. The represented shape of centering mandrel 40 can be different, the important point is to stabilize the web of strips of material 2 that begins to bend by means of at least one longitudinal angular zone that locks transversally strips of material 2 with respect to one another.

A temporary longitudinal mandrel 41 arranged downstream of centering mandrel 40 and upstream of forming mandrel 3 can be provided when it is necessary to weld a barrier film forming an internal membrane or layer provided inside of the tubular box bodies to be manufactured in order to comply with tightness requirements. To facilitate this operation and guarantee an optimum welding quality, this temporary mandrel 41 has a water drop-shaped cross-section whose development corresponds to the development of the internal cross-section D of the tubular box bodies to be manufactured (FIGS. 2 and 4C). Cylindrical press rollers (not represented) are provided in contact on the inclined and opposite sides of temporary mandrel 41 to press the barrier film around said mandrel and pull it upwards to have the welding operation carried out by a welding station 42 adjacent to said mandrel and using for example ultrasound or the like. If the barrier film must be glued instead of welded, temporary mandrel 41 is not helpful. However, a glue nozzle (not represented) is located at this level to apply glue on at least one of the longitudinal edges of said barrier film before bending them with the other strips of material 2. In other cases, the tubular box bodies can be manufactured without barrier film.

When leaving temporary mandrel 41 if it is used or in the continuity of centering mandrel 40, and upstream of forming mandrel 3, the web of strips of material 2 is bent laterally by a bending roller 43 that has a profile complementary to temporary half mandrel 41 or to centering mandrel 40 (FIGS. 2 and 4D). This bending roller 43 is mounted free in rotation about its axis to avoid any friction on the web. At this point, machine 1 can be advantageously completed with a glue nozzle 44 located in front of the offset edges 6 of strips of material 2 to add glue on these zones that tend to dry in the air. Adding this glue nozzle 44 therefore allows reducing notably the quantity of glue between strips of material 2 that are previously coated with glue in a gluing station (not represented) before they are superimposed in a web, and consequently reducing the residual moisture of the manufactured box bodies. The fact of adding glue just before bending the longitudinal edges 6 of strips of material 2 has the advantage of allowing uniform high-quality bonding all along said longitudinal joint 5. Along forming mandrel 3 (FIG. 3), in the direction of the movement of tubular profile 4, the press rollers 21 forming pressing means 20 that shape and roll the web of strips of material 2 around said mandrel, are distributed symmetrically with respect to said mandrel, from its lower section (FIG. 4E) against which the web arrives to its upper section (FIG. 4I) against which the web closes to form tubular profile 4.

In the represented example, there are eight press rollers 21, 21′:

FIG. 4E, a first press roller 21, symmetrical and centered on the lower section of forming mandrel 3, rolling the web of strips of material 2 on a first sector covering about ¼ of the periphery of forming mandrel 3,

FIG. 4F, a second and a third half press rollers 21′, arranged symmetrically, bending and rolling the web of strips of material 2 on the second and third lower lateral sectors, covering each about ⅛^{th} of the periphery of forming mandrel 3,

FIG. 4G, a fourth and a fifth half press rollers 21′, arranged symmetrically, bending and rolling the web of strips of material 2 on the fourth and fifth median lateral sectors, covering each about ⅛^{th} of the periphery of forming mandrel 3,

FIG. 4H, a sixth and a seventh half press rollers 21′, arranged symmetrically, bending and rolling the web of strips of material 2 on the sixth and seventh upper lateral sectors, covering each about ⅛^{th} of the periphery of forming mandrel 3, and

FIG. 4I, an eighth press roller 21, or, in the represented example, a series of five press rollers 21 aligned, symmetrical and centered on the upper section of forming mandrel 3, rolling the junction zone of the longitudinal edges of strips of material 2 on an eighth and last sector covering about ¼ of the periphery of forming mandrel 3. The series of press rollers 21 furthers the quality of the bonding of the longitudinal edges with each another.

This description shows clearly that the invention allows reaching the goals defined. In particular, this new design allows sequencing the closing of the press rollers when starting the machine and therefore automatizing the start-up, generating substantial gains. Likewise, the format changes for the tubular box bodies to be manufactured are faster, as well as the maintenance operations. Moreover, the box bodies manufactured using this process have a better quality, both from the mechanical strength point of view and from the barrier features point of view.

The present invention is not restricted to the example of embodiment described, but extends to any modification and variant which is obvious to a person skilled in the art while remaining within the scope of the protection defined in the attached claims.

1-15. (canceled)

16. A machine (1) for continuous manufacture of tubular box bodies to be manufactured, the machine comprising:
at least one longitudinal forming mandrel (3) whose cross-section corresponds to an internal cross-section of the tubular box bodies to be manufactured and around which at least one longitudinally unwound and previously at least partly glue-coated strip of material (2) is applied and folded in order to form a closed tubular profile (4),
pressing means (20) arranged for rolling the at least one strip of material (2) against the forming mandrel (3), and
traction means (10) arranged for moving continuously the tubular profile (4) along the forming mandrel (3),
wherein the pressing means (20) and the traction means (10) are distinct and the pressing means (20) comprise a plurality of press rollers (21, 21′) mounted free in rotation about their axis, and the press rollers are deformable and radially distributed around the forming mandrel (3) so as to fit a periphery of the mandrel.

17. The machine according to claim 16, wherein the press rollers (21,21′) are distributed symmetrically around the forming mandrel (3), each covering a sector of the mandrel, and are offset longitudinally so as to cover an entire periphery of the mandrel.

18. The machine according to claim 16, wherein every press roller (21, 21′) comprises a lining (23) made out of an elastic material.

19. The machine according to claim 18, wherein the elastic lining (23) of every press roller (21, 21′) has a complementary profile to that of the sector of the forming mandrel (3) against which the corresponding press roller is pressed.

20. The machine according to claim 18, wherein the elastic lining (23) comprises internal recesses (23′) arranged to increase its elasticity.

21. The machine according to claim 18, wherein the elastic material of the lining is selected from the group consisting of natural rubbers and polyurethane-based synthetic rubbers.

22. The machine according to claim 16, wherein each press roller (21, 21′) is carried by a support (26) whose radial position is adjustable with respect to the forming mandrel (3).

23. The machine according to claim 22, wherein each press roller (21, 21′) is coupled with a pressurizing element carried by the support (26).

24. The machine according to claim 16, wherein the machine further comprises a longitudinal centering mandrel (40) arranged upstream of the forming mandrel (3) and having a polygonal cross-section whose development is smaller than the development of the internal cross-section of the tubular box bodies to be manufactured, and the centering mandrel (40) is arranged to guide the strips of material (2) longitudinally and transversally without slipping.

25. The machine according to claim 24, wherein the machine further comprises a temporary longitudinal mandrel (41) arranged downstream of the centering mandrel (40) and upstream of the forming mandrel (3) and having a water drop-shaped cross-section whose development corresponds to the development of the internal cross-section (D) of the tubular box bodies to be manufactured.

26. The machine according to claim 25, wherein the machine further comprises a welding station (42), adjacent to the temporary mandrel (41), for welding the longitudinal edges of at least one strip of material forming the internal layer of the tubular box bodies to be manufactured.

27. The machine according to claim 16, wherein the machine further comprises a series of press rollers (21) aligned on a longitudinal sector of the forming mandrel (3) corresponding to an area where the longitudinal edges of the at least one strip of material (2) meet to close the tubular profile (4) by at least one longitudinal joint.

28. The machine according to claim 16, wherein the traction means (10) comprise at least one traction belt (11) carried by drive rollers (12) and arranged downstream of the pressing means.

29. The machine according to claim 28, wherein the traction means (10) comprise at least two traction belts (11) arranged symmetrically with respect to the forming mandrel (3).

30. The machine according to claim 16, wherein the machine further comprises at least one gluing nozzle (44) arranged to add glue on at least some of the longitudinal edges of the strips of material (2).

31. A machine (1) for continuous manufacture of tubular box bodies to be manufactured, the machine comprising:
at least one longitudinal forming mandrel (3) having a cross-section which corresponds to an internal cross-section of the tubular box bodies to be manufactured, and around which at least one longitudinally unwound and previously at least partly glue-coated strip of material (2) is applied and folded in order to form a closed tubular profile (4),
pressing mechanism (20) arranged for rolling the at least one strip of material (2) against the forming mandrel (3), and
traction mechanism (10) arranged for continuously moving the tubular profile (4) along the forming mandrel (3),
wherein the pressing mechanism (20) and the traction mechanism (10) are distinct from one another and the pressing mechanism (20) comprises a plurality of press rollers (21, 21′) mounted free in rotation about their axis, and the press rollers are deformable and radially distributed around the forming mandrel (3) so as to fit a periphery of the mandrel.
